(19) United States
(12) Patent Application Publication
(10) Pub. No.: US 2011/0279171 A1
(43) Pub. Date: Nov. 17, 2011

(54) ELECTRICALLY PROGRAMMABLE FUSE CONTROLLER FOR INTEGRATED CIRCUIT IDENTIFICATION, METHOD OF OPERATION THEREOF AND INTEGRATED CIRCUIT INCORPORATING THE SAME

(75) Inventors: Lihui Cao, San Jose, CA (US); Saket K. Goyal, San Jose, CA (US); Thai-Minh Nguyen, San Jose, CA (US)

(73) Assignee: LSI Corporation, Milpitas, CA (US)

(21) Appl. No.: 12/778,305

(22) Filed: May 12, 2010

(51) Int. Cl. H01H 37/76

(52) U.S. Cl. 327/525

(57) ABSTRACT

An electrically programmable fuse controller, a method of controlling a drive voltage of an integrated circuit (IC) and an IC incorporating the controller or the method. In one embodiment, the controller includes a VID eFuse controller configured to receive and write a voltage identifier to an associated eFuse and thereafter allow the voltage identifier to be read from the eFuse and employed to set a drive voltage of an integrated circuit associated with the VID eFuse controller.

### TECHNICAL FIELD

This application is directed, in general, to integrated circuits (ICs) employing voltage scaling and, more specifically, to an electrically programmable fuse (“eFuse”) controller for IC identification, a method of operation thereof and an IC incorporating the same.

### BACKGROUND

Speed and power consumption are important performance considerations in integrated circuits (ICs, colloquially called “chips”). Speed often determines the utility of the IC. Power consumption affects the cost, reliability, yield and lifetime of the IC.

Power consumption is proportional to the square of the supply voltage. Speed varies approximately linearly with respect to the supply voltage and depends on the process employed to fabricate it. Due to inexact fabrication process control, ICs are subject to variations in fabrication process, which causes them to perform differently in terms of their speed. As a result, when a nominal supply voltage is applied to a particular lot of ICs, some will operate at speeds higher than the targeted value, others will operate at speeds approximating the targeted value, and the remaining ones will operate at speeds lower than the targeted value. For those faster ICs, the supply voltage (and power dissipation) can be reduced. For those slower ICs, the supply voltage can be increased. While the power dissipation increases, speed is increased, the performance requirement is met, and yield is enhanced.

### SUMMARY

One aspect provides an eFuse controller. In one embodiment, the controller includes a VID eFuse controller configured to receive and write a voltage identifier (VID) to an associated eFuse and thereafter allow the VID to be read from the eFuse and employed to set a drive voltage of an integrated circuit associated with the VID eFuse controller.

Another aspect provides a method of controlling a drive voltage of an IC. In one embodiment, the method includes: (1) receiving and writing a VID to an eFuse and (2) thereafter allowing the VID to be read from the eFuse and employed to set the drive voltage of the IC.

Yet another aspect provides an IC. In one embodiment, the IC includes: (1) an IC substrate, (2) functional circuitry located in or on the substrate and (3) an eFuse controller located in or on the substrate, coupled to the functional circuitry and including a VID eFuse controller configured to receive and write a VID to an associated eFuse and thereafter allow the VID to be read from the eFuse and employed to set a drive voltage of an IC associated with the VID eFuse controller.

### BRIEF DESCRIPTION

Reference is now made to the following descriptions taken in conjunction with the accompanying drawings, in which:

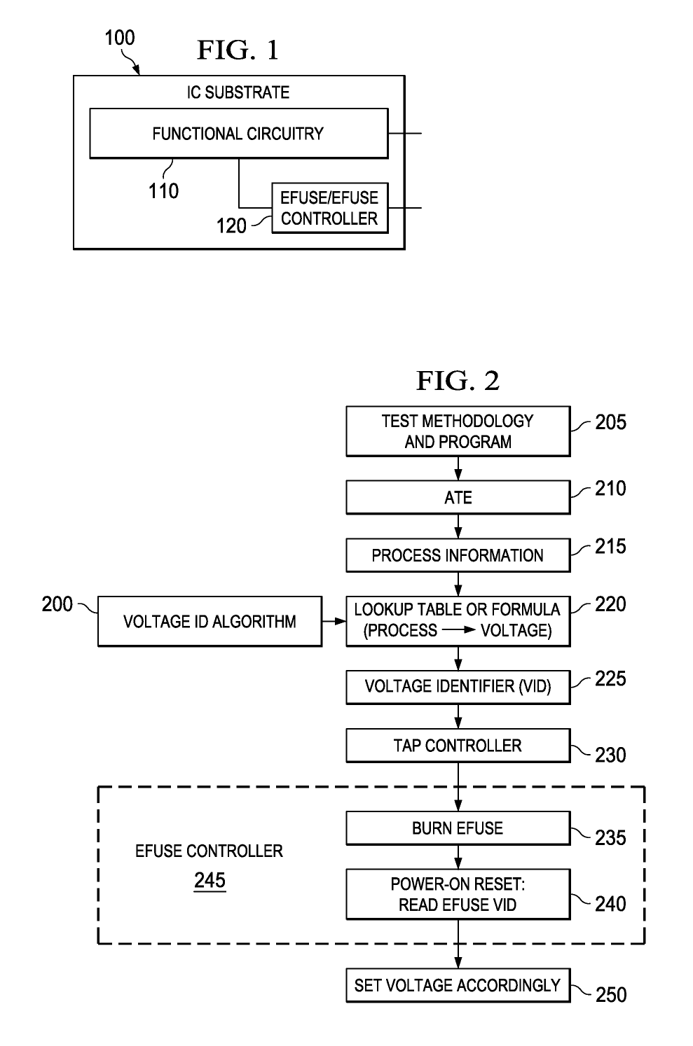

FIG. 1 is a highly schematic plan view of an IC into which an eFuse may be integrated;

FIG. 2 is a flow diagram of one embodiment of a process flow by which a VID may be created, stored and retrieved;

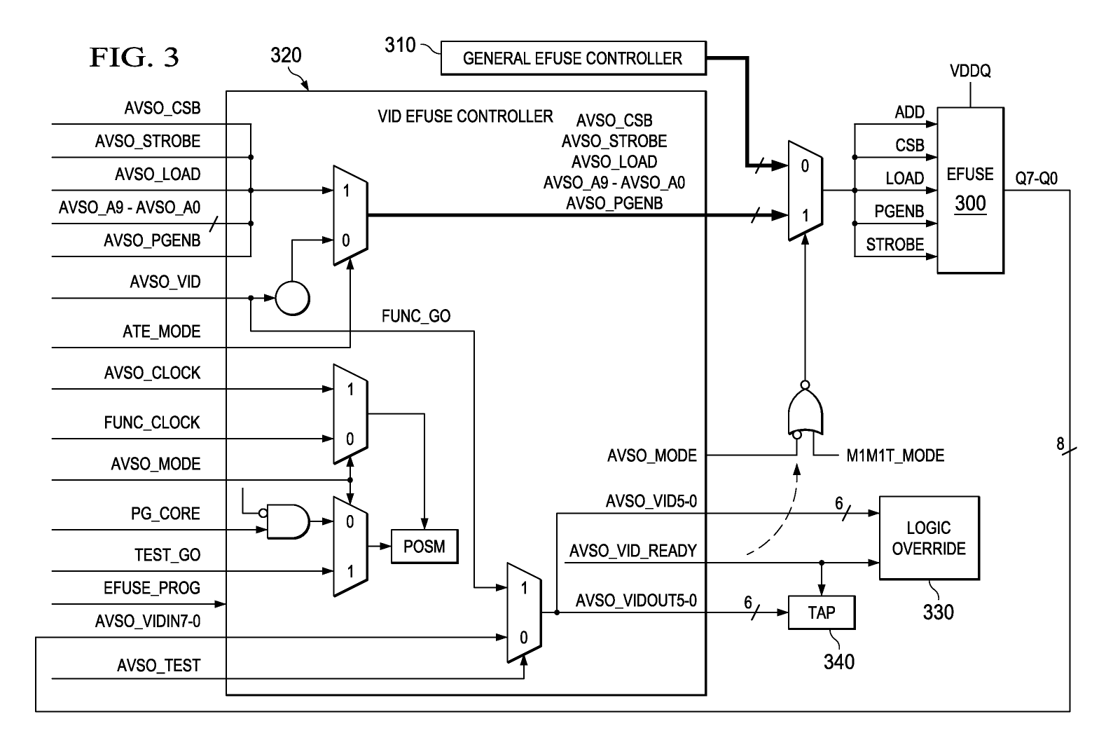

FIG. 3 is a block diagram of one embodiment of an eFuse controller and interfacing blocks associated therewith; and

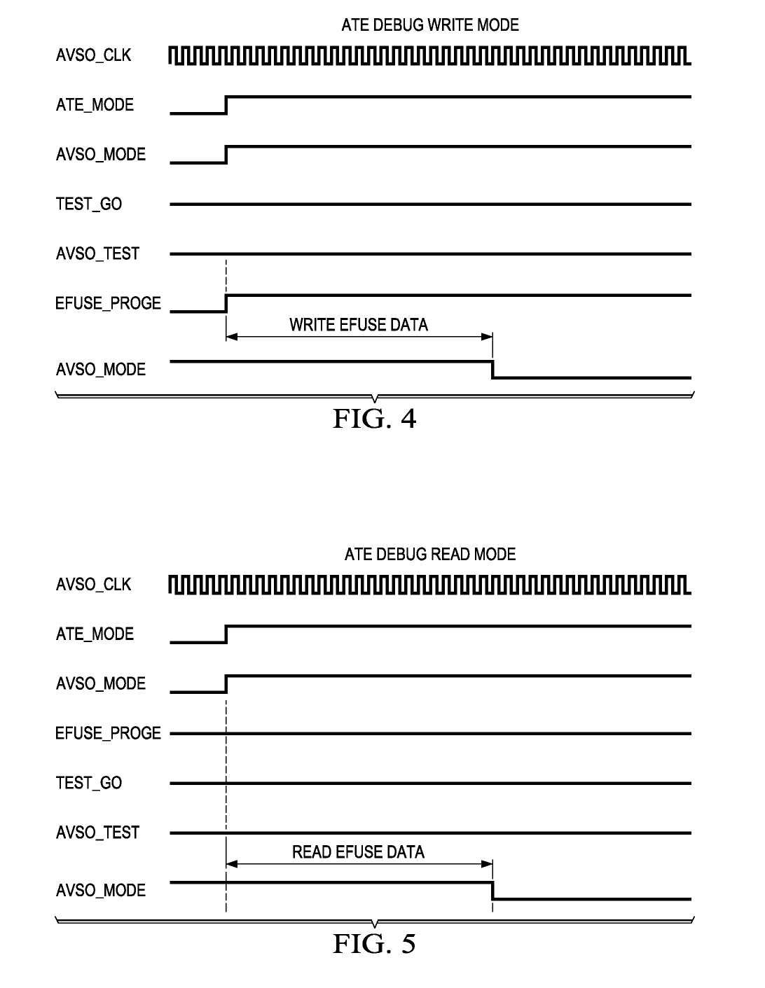

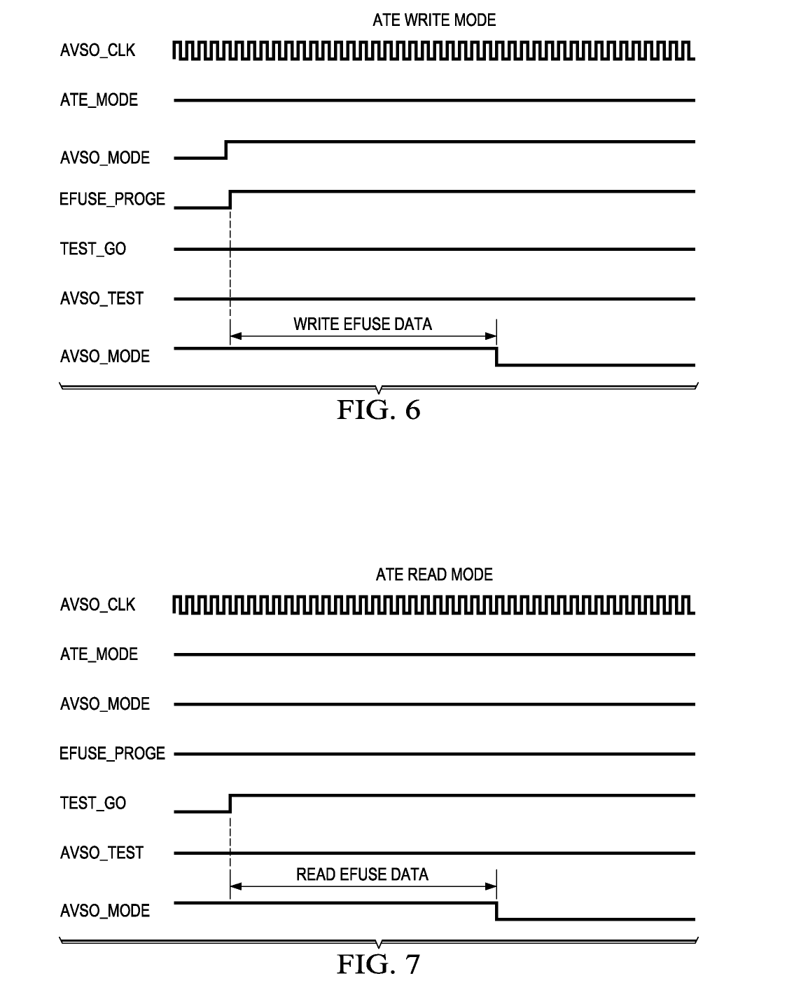

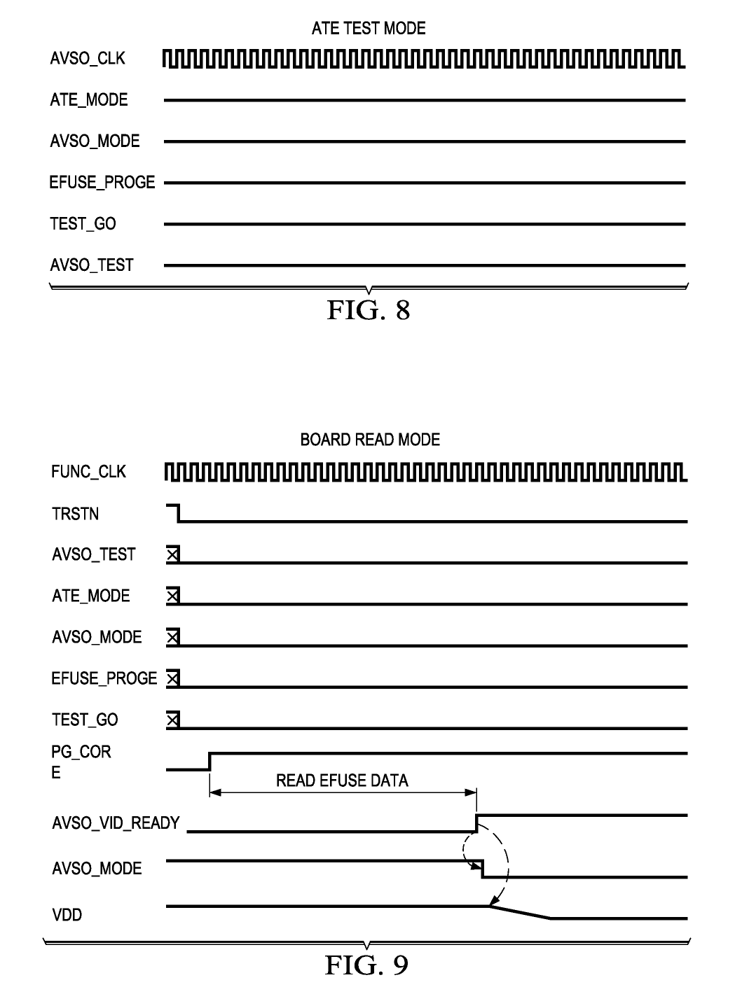

FIGS. 4-9 are timing diagrams for different operating modes of the eFuse controller of FIG. 3.

### DETAILED DESCRIPTION

Conserving resources, including energy, has become a pre-eminent objective in today's world. Manufacturers of ICs are sensitive to the need to improve the energy efficiency of their products. Some ICs employ voltage scaling (VS), a technique that allows an operating voltage to be chosen such that the IC meets performance goals. More sophisticated ICs may employ adaptive voltage scaling (AVS), wherein VS is carried out repeatedly over time further to improve the performance of the IC. AVS calls for the supply voltage to be adjusted in response to real-time measurements of signal propagation speed to ensure that the IC operates as intended.

The most sophisticated of today's ICs are designed with AVS taken into account. In such “AVSO ICs,” the very architecture of the IC is chosen such that it can be powered at the lowest possible voltage without sacrificing performance. Not only does the IC typically require substantially less power, it can be designed faster than conventionally thought possible. AVSO has demonstrated its ability to conserve energy and therefore is expected to be evermore widely used in future ICs.

Described herein are various embodiments of a system and method by which an already-fabricated IC may be programmed with information employable to determine the supply voltage at which it may be operated to achieve a desired target performance (i.e., speed). In various embodiments that are particularly advantageous in ICs that employ voltage scaling or adaptive voltage scaling (AVS), a number (herein called a VID) may be stored in an eFuse associated with the IC (e.g., located on the substrate of the IC itself or electrically coupled to circuitry on the substrate of the IC) and then read out and used to scale the supply voltage to the IC at an appropriate level or set the supply voltage at a nominal, “midpoint” level about which AVS may be carried out.

FIG. 1 is a highly schematic plan view of an IC into which an eFuse may be integrated. FIG. 1 shows an IC substrate 100, which may be composed of any conventional or later-developed substrate material. The IC substrate 100 functions as a foundation in which or on which is fabricated integrated circuitry, including electronic devices (e.g., transistors, diodes and capacitors) and interconnecting conductors (e.g., “metallization”). FIG. 1 shows functional circuitry 110, which represents integrated circuitry located in or on the IC substrate 100 and typically forming the majority of an IC. The functional circuitry 110 may include analog circuitry, digital logic such as a processor or controller, digital memory such as random-access, read-only or flash memory or any other conventional or later-developed circuitry as may be appropriate for a given application. The functional circuitry 110 may be fabricated using any conventional or later-developed fabrication process or scale. The functional circuitry 110 includes at least one unreferenced external conductor (colloquially, a “pin”) that allows electrical contact to be made between the functional circuitry 110 and external circuitry (not shown).

An eFuse and controller 120 is coupled to the functional circuitry 110. The illustrated embodiment of the eFuse and controller 120 likewise includes at least one unreferenced external conductor that allows electrical contact to be made between the eFuse and controller 120 and external circuitry (not shown). As will be described more particularly in conjunction with FIG. 2, the eFuse and controller 120 includes an eFuse and control circuitry configured to write data to, and read data from, the eFuse. Various embodiments of the eFuse and controller 120 also include either or both of various embodiments of an inhibitor. While not shown in FIG. 1, various embodiments of the inhibitor inhibit, and perhaps prevent, a VID from being written to the eFuse. In certain embodiments, the inhibitor is enabled only after at least one VID is written to the eFuse. In various of those embodiments, this allows the VID to be stored persistently in the eFuse.

FIG. 2 is a flow diagram of one embodiment of a process flow by which a VID may be created, stored and retrieved. The method begins in a step 205 in which a test methodology, typically embodied in a test program, is provided to automated test equipment (ATE) 210. The ATE then performs tests as defined in the test program on an IC and gathers process information, and perhaps other information, as a result of a step 215. The process information may then be employed to generate a VID. In one embodiment, one or more process monitors or equivalent circuits are employed to determine IC characteristics (e.g., signal propagation speed). The process characteristics are used to calculate a certain number of bits voltage ID (VID) for the specific device. In the embodiment of FIG. 2, a VID algorithm 200 is employed to accept the process information as an input and produce a VID 225 as an output. In one embodiment, the VID algorithm 200 includes a formula. In an alternative embodiment, the VID algorithm 200 includes a lookup table. In yet another embodiment, the VID algorithm includes a formula and a lookup table.

The VID is then programmed thorough the eFuse controller into an eFuse block. In the embodiment of FIG. 2, the VID 225 is then provided to the IC via a test access port (TAP) controller 230 via a TAP. The VID is written (e.g., “burned”) into the eFuse in a step 235. In the embodiment of FIG. 2, the VID is then verified in a step 240 in which a power-on reset is performed to retrieve the VID from the eFuse, and the retrieved VID is compared to the original VID to confirm its correctness. An eFuse controller 245 may carry out the steps 235, 240. The VID now having been placed in the eFuse, the IC may be powered on, the VID retrieved and the drive voltage of the IC set in accordance with the VID in a step 250.

FIG. 3 is a block diagram of one embodiment of an eFuse controller and interfacing blocks associated therewith. The eFuse controller includes a general eFuse controller 310 and a VID eFuse controller 320 that are configured to control an eFuse 300 to write data thereto and read data therefrom. In the embodiment of FIG. 3, the eFuse 300 is configured to store substantially more data than just the VID. In one embodiment, the eFuse 300 can store up to 1028 bits, although other sizes are within the scope of the invention. Accordingly, the general eFuse controller 310 is configured to control the eFuse 300 with respect to data other than the VID, and the VID eFuse controller 320 is configured to control the eFuse 300 with respect to the VID. The VID eFuse controller 320 is configured to provide the VID, conveyed via AVSO_VIDOUT5-0 output pins, to a TAP 340. The VID eFuse controller 320 is further configured to provide the VID and a VID ready indication signal to a logic override block 330. The latter is conveyed by an AVSO_VID_READY output pin. The TAP 340 is configured to provide access to ATE (not shown). FIG. 3 illustrates a plurality of input pins. The pins labeled ATE_MODE, AVSO_MODE, AVSO_TEST, PG_CORE, TEST_GO and CLOCK are configured to allow signals to be provided to the VID eFuse controller 320 to select modes of operation as will be described below.

In the embodiment of FIG. 3, process characterization, VID calculation and eFuse programming are carried out during ATE testing. On the power-up of the IC, the VID eFuse controller 320 downloads the VID from the eFuse 300, and either an external voltage regulator or on-chip IC regulator employs the VID to set the supply voltage. The VID calculated during ATE testing is stored in the eFuse 300. The VID eFuse controller 320 is coupled to a TAP controller 340 to program the VID during ATE and download the VID during power-up, prior to downloading an eFuse built-in self-repair (BISR) solution.

Various embodiments of the eFuse controller are capable of operating in more than one mode. The embodiment of FIG. 3 is capable of operating in the following modes to facilitate debugging, testing and bypassing. In an ATE Debug Write mode, data is written to the eFuse 300 by the ATE, bypassing the VID eFuse controller 320. In an ATE Debug Read mode, data stored in the eFuse 300 is read by the ATE, bypassing the VID eFuse controller 320. In an ATE Write mode, data is written to the eFuse 300 by the ATE through the VID eFuse controller 320. In an ATE Read mode, data stored in the eFuse 399 is read by the ATE through the VID eFuse controller 320. In an ATE Test mode, data provided via the AVSO_VID input goes directly to the AVSO_VID5-0 outputs for testing purposes. In a Board Read mode, data stored in the eFuse 300 is read through the VID eFuse controller 320 at power-up.

Table 1, below, shows the states of ATE_MODE, AVSO_MODE, AVSO_TEST, PG_CORE, TEST_GO and CLOCK input signals to enable each of the modes.

TABLE 1
eFuse Controller Modes of Operation

| | | | | | ATE | | Board |
|---|---|---|---|---|---|---|---|
| | | ATE | ATE | | Read | | Read |
| | | Debug | Debug | ATE | Mode | ATE | Mode |
| | | Write | Read | Write | (Use | Test | (Use |
| Pin | Type | Mode | Mode | Mode | POSM) | Mode | POSM) |
| ATE_MODE | Input | 1 | 1 | 0 | 0 | 0 | 0 by |
| | | | | | | | Tap |
| | | | | | | | Reset |
| AVSO_MODE | Input | 1 | 1 | 1 | 1 | 1 | 0 by |
| | | | | | | | Tap |
| | | | | | | | Reset |
| EFUSE_PROG | Input | 1 | 0 | 1 | 0 | 0 | 0 by |
| | | | | | | | Tap |
| | | | | | | | Reset |
| AVSO_TEST | | 0 | 0 | 0 | 0 | 1 | 0 by |
| | | | | | | | Tap |
| | | | | | | | Reset |
| PG_CORE | Input | x | x | x | x | x | On |
| | | | | | | | Rising |
| | | | | | | | Edge |
| TEST_GO | Input | 0 | 0 | 0 | On | | 0 by |
| | | | | | Rising | | Tap |
| | | | | | Edge | | Reset |
| CLOCK | Input | AVSO_CLK | AVSO_CLK | AVSO_ CLK | AVSO_CLK | AVSO_CLK | FUNC_CLK |

FIGS. 4-9 illustrate example timing diagrams for different operating modes of the eFuse controller of FIG. 3. Those skilled in the pertinent art will understand, however, that these timing diagrams may not apply to other embodiments of the eFuse controller.

Those skilled in the art to which this application relates will appreciate that other and further additions, deletions, substitutions and modifications may be made to the described embodiments.

What is claimed is:

1. An electrically programmable fuse controller, comprising:
a VID eFuse controller configured to receive and write a voltage identifier to an associated eFuse and thereafter allow said voltage identifier to be read from said eFuse and employed to set a drive voltage of an integrated circuit associated with said VID eFuse controller.

2. The controller as recited in claim 1 wherein said VID eFuse controller is coupled to a test access port and is further configured to receive said voltage identifier via a test access port.

3. The controller as recited in claim 1 further comprising a general eFuse controller coupled to said eFuse and configured to control said eFuse with respect to data other than said voltage identifier.

4. The controller as recited in claim 1 wherein said VID eFuse controller is coupled to a logic override block.

5. The controller as recited in claim 1 wherein said voltage identifier is a product of a voltage identifier algorithm based on process information.

6. The controller as recited in claim 1 wherein said eFuse is configured to store up to 1028 bits.

7. The controller as recited in claim 1 wherein said VID eFuse controller and said eFuse are located on an integrated circuit substrate together with functional circuitry included in said integrated circuit.

8. A method of controlling a drive voltage of an integrated circuit, comprising:
receiving and writing a voltage identifier to an eFuse; and
thereafter allowing said voltage identifier to be read from said eFuse and employed to set said drive voltage of said integrated circuit.

9. The method as recited in claim 8 wherein said receiving comprises receiving said voltage identifier via a test access port.

10. The method as recited in claim 8 further comprising controlling said eFuse with respect to data other than said voltage identifier.

11. The method as recited in claim 8 wherein said method is carried out in a VID eFuse controller coupled to a logic override block.

12. The method as recited in claim 8 wherein said voltage identifier is a product of a voltage identifier algorithm based on process information.

13. The method as recited in claim 8 wherein said eFuse is configured to store up to 1028 bits.

14. The method as recited in claim 8 wherein said method is carried out in a VID eFuse controller and said VID eFuse controller and said eFuse are located on an integrated circuit substrate together with functional circuitry included in said integrated circuit.

15. An integrated circuit, comprising:
an integrated circuit substrate;
functional circuitry located in or on said substrate; and
an electrically programmable fuse controller located in or on said substrate, coupled to said functional circuitry and including a VID eFuse controller configured to receive and write a voltage identifier to an associated eFuse and thereafter allow said voltage identifier to be read from said eFuse and employed to set a drive voltage of an integrated circuit associated with said VID eFuse controller.

16. The integrated circuit as recited in claim 15 wherein said VID eFuse controller is coupled to a test access port located in or on said substrate and is further configured to receive said voltage identifier via a test access port.

17. The integrated circuit as recited in claim 15 further comprising a general eFuse controller located in or on said substrate, coupled to said eFuse and configured to control said eFuse with respect to data other than said voltage identifier.

18. The integrated circuit as recited in claim 15 wherein said VID eFuse controller is coupled to a logic override block located in or on said substrate.

19. The integrated circuit as recited in claim 15 wherein said voltage identifier is a product of a voltage identifier algorithm based on process information pertaining to said functional circuitry.

20. The integrated circuit as recited in claim 15 wherein said eFuse is configured to store up to 1028 bits.
